(19) United States
(12) Patent Application Publication
(10) Pub. No.: US 2006/0074976 A1
(43) Pub. Date: Apr. 6, 2006

(54) Devices and method for recording and analyzing temporal events

(76) Inventors: Laurent Cauvin, Chevaigne (FR); Gilles Morillon, Melesse (FR)

Correspondence Address: THOMSON LICENSING INC., PATENT OPERATIONS, PO BOX 5312, PRINCETON, NJ, 08543-5312, US

(21) Appl. No.: 10/538,960

(22) PCT Filed: Dec. 15, 2003
(86) PCT No.: PCT/EP03/51006

§ 371 Date: Jun. 14, 2005

(30) Foreign Application Priority Data
Dec. 17, 2002 (FR) 02/15963

(51) Int. Cl. G06F 17/00

(52) U.S. Cl. 707/104.1

(57) ABSTRACT

A device and a method for temporal metering of events and to a device and a method for temporal analysis of events. The temporal metering device when operating obtains current times for each occurrence of physical events, and records in at least one metering file, information authorizing a temporal reconstitution of the occurrences. This device comprises a module for summary processing of the occurrences and of the current times, producing condensed results which are recorded in predefined data structures of prefixed sizes of the metering file, so as to make it possible to keep the size of this file constant during successive recordings of this information. Applications to checks of software services and to analyses of computing malfunctions.

The present invention concerns devices and methods for temporal metering and temporal analysis of events, in particular applicable to software services. It may relate in particular to the checking of occurrences of events or the analysis of malfunctions in relation to these events.

The development of computer networks has multiplied the possibilities of remotely accessing services available on certain machines, such as in particular games, educational programs, videos or music. The software services, in particular, rely on the presence of an executable piece of software in one of the machines and on access so as to execute this software from an appliance linked to this machine by a network. It then turns out to be very useful to be able to maintain a temporal trace of the successive calls, so as to set up effective management going beyond simple addition of the calls and be capable of diagnosing with more capabilities the circumstances and causes of any malfunctions.

Such monitoring is for example valuable for a software supplier licensing his product to a service provider and receiving a remuneration which depends on the number of calls for a given period. The existence of files summarizing all the calls made, created at the premises of the service provider but accessible to the software supplier, then allows the latter to check the actual number of calls and to bill the service provider accordingly.

However, consecutive records of the times of calls lead to files of increasing and rapidly cumbersome, or even prohibitive, sizes once the number of calls becomes significant.

Patent application WO-01/82033 discloses a procedure for detecting use of program for billing purposes. According to this procedure, all the calls to a function of the program are recorded in a log file, so as to make it possible to bill the licensee as a function of the extent of utilization of the program. An identification representing the number of calls is then co-recorded with an identification of the system time and a cryptographic signature, after a predetermined number of calls or in first predefined time intervals.

The number of records is thus reduced, since the latter are not made systematically, but episodically. However, insofar as the results obtained are recorded at a sufficient frequency to remain reliable, this procedure does not solve the problem of increasing file size, but can only attenuate or delay the effects thereof.

It would moreover be conceivable to transfer the results obtained to an independent storage space, either in real time, or as soon as the information files reach a predefined size. However, such a mechanism is at risk of requiring fairly voluminous storage resources, and necessitates the installing of a transfer device that is penalizing for the effective operation of the machine containing the software.

U.S. Pat. No. 6,026,139 discloses a counting procedure able to generate a frequency distribution representation such as a histogram. An integrated device counts the numbers of occurrences of a predetermined type of events in measurement periods, doing so during a period of sub-experimentation associated with given parameters. At the end of each of the measurement periods, a frequency counter is incremented when the number of occurrences is greater than a predefined threshold value. These operations make it possible to obtain for the period of sub-experimentation the number of measurement periods during which the targeted events have occurred in a significant manner. One proceeds in a similar manner for the whole set of successive periods of sub-experimentation, this leading to a frequency distribution based on the number of periods of measurements adopted for each period of sub-experimentation. It is thus possible to compare various frequencies of occurrences according to the parameters chosen.

This technique considerably reduces the information to be recorded, and therefor the storage size required, but to the detriment of the temporal information regarding the events.

The present invention relates to a device for temporal metering of calls to a software service available on a machine, possibly capable of providing significant results while yet solving the problem of increasing sizes of log files, and without prejudicing the current operation of the machine.

More generally, the invention relates to a device for temporal metering of events, which can make possible an at least partial temporal reconstitution of the occurrences of these events, which reconstitution is sufficient to obtain the desired cues, while yet offering the advantages mentioned above. It may be particularly beneficial in respect of embedded systems.

The invention also relates to a method of metering events corresponding to the metering device of the invention, and to a device and a method of temporal analysis of events making it possible to utilize results obtained by means of a device or of a method of metering events according to the invention.

It applies in particular to the checking of calls to a software service, for the purposes of billing or of diagnosis of malfunctions. However, it can also be applied to other types of checking or analysis of malfunctions, such as in particular:

the monitoring of the use of a computing functionality available on a machine; this makes it possible to retrace the use of a function in case of a software or hardware fault;

the monitoring of telephone calls, made from a telephone exchange and/or received by the latter;

the monitoring of orders and of deliveries of video programs (VOD standing for “Video On Demand”) or audio programs (MP3 files for example) pertaining to a server (or several);

the monitoring of maneuvers performed in a repeated manner on motor vehicles, for example the use of brakes, of the accelerator and/or of the gearbox;

the monitoring of circumstantial events, for example in the aeronautical field the presence at altitudes above (or below) a threshold, and in the medical field, the overshoots of a ceiling, or undershoots of a floor, of amounts of an element in the blood (insulin, glucose, white cells, etc.).

For this purpose, the subject of the invention is a device for temporal metering of events, comprising:

a module for real time input of occurrences of physical events,

a module for access to at least one clock, which module is designed to obtain a current time with each input of one of the occurrences,

and a module for recording in at least one metering file, information pertaining to these occurrences and to the corresponding current times, this information authorizing an at least partial temporal reconstitution of the occurrences.

According to the invention, the metering device also comprises a module for summary processing of the occurrences and of the current times, which module is designed to produce condensed results. Furthermore, the recording module is designed to record the condensed results in predefined data structures of prefixed sizes of the metering file, so as to make it possible to keep the size of the file constant during successive recordings of the information.

Thus, contrary to all expectations, the temporal information desired may be brought together in a form summarized into a file of constant size, or into several predefined files each having a constant size. This surprising result relies on the one hand on the summary processing of the occurrences and of the times, which makes it possible to reduce the number of items of information to be stored, and on the other hand on the use of predefined data structures of prefixed sizes in the metering file (or in each of the files).

Specifically, each of these data structures is associated with a specific item of information and with a corresponding processing. For example, the data structure may consist of a word of four bytes which is intended to receive the aggregate number of occurrences that have arisen between 12 pm and 1 pm each day for a week. In another example, the data structure is intended to receive the number of times that occurrences have arisen during more than one minute in a row, the events examined corresponding to measurements performed with a temporal sampling stepsize of 2 seconds. The summary processing performed therefore relies on specific algorithms making it possible to “consolidate” the results.

The at least partial temporal reconstitution pertains to the targeted aims: if one wishes to pinpoint a malfunction in time to within one second, the information recorded must be sufficient to pinpoint to within one second all the occurrences that have arisen; if one wishes to check the calls to a piece of software, the information must make it possible to dependably ascertain the number of calls and to at least statistically verify their temporal distribution. In all cases, the temporal reconstitution makes it possible at least to approximately reconstitute the log of the events that have occurred.

Two categories of events to which the device of the invention has the ability to be applied may be distinguished:

those which are detected passively when they happen in a punctuated manner, in a way which generally cannot be forecast in the detail of their occurrences; this category includes for example telephone calls or calls to a piece of software, the switching on of engines or depressions of a brake;

and those which are caused by measurements, at determined sampling instants; this category relies for example on measurements of altitudes or of speeds, the events consisting of certain particular features of the altitudes or speeds measured (the speed overshoots predefined safety levels, the altitude goes below or above critical altitudes, etc.).

To process one type of events, the use of a single file is preferred. It is thus possible to concentrate all the information required, thereby simplifying and easing accesses in record mode and then the steps of utilization. Additionally, when several categories of distinct events are of interest, several metering files are preferably used, one file per category of events. This embodiment facilitates independence of the processing operations and of the utilization of the results, and clarifies the use of these files.

Access to the clock or to the clocks may be direct or otherwise. For example, in a particular embodiment, the metering device is informed at one and the same time of the occurrence of an event and of the associated instant, by one or more external systems. The combined utilization of several clocks assumes their appropriate synchronization, at least when they pertain to one and the same type of events.

The possibility of obtaining files of fixed sizes is especially beneficial in respect of embedded systems, for which the storage considerations may be decisive.

In a preferred form of embodiment, the summary processing module is designed to produce at least two types of distinct results, at least one of these types of results comprising redundancies with respect to the other types of results, so as to allow checks of consistency of the results.

This embodiment is especially relevant in respect of checks made on the events that have happened, for example to verify the number of calls to a software service at a licensee's with a view to billing, the files then advantageously being encrypted.

In this preferred embodiment, it is advantageous for the summary processing module to be designed so that the various types of results provide complementary information. Thus, the existence of several types does not serve only to validate the results in a more reliable manner, but also to aggregate information useful for later analyses.

According to a preferred mode of these types of results, the latter comprise:

a first type of results consisting of numbers of said occurrences per slot of durations of gaps between two of the consecutive occurrences

and a second type of results consisting of numbers of the occurrences per consecutive time slot of a predetermined period.

Thus, to the information regarding succession of the events per time slot within a given timescale, for example during a month (second type of results), is added information on the distribution of the events according to the durations which separate them (first type). It is thus possible to refine the cues pertaining to the chronological progress, by interesting oneself in the frequency of occurrences.

Preferably, the slots of durations of gaps of the first type of results then have amplitudes increasing not strictly with these durations (that is to say which grow with the durations but may admit plateaux).

According to several interesting provisions for embodying the metering device of the invention, the physical events comprise, separately or in combination(s):

calls to a piece of software situated on a source machine by appliances able to communicate with this machine;

telephone calls;

predefined maneuvers in a motor vehicle, for example the use of the brakes in order to ascertain whether the wear to the brake pads is normal or otherwise;

uses of computer functionalities available on a machine and liable to undergo malfunctions on account of technical problems; for example, to analyze the origin of computer crashes, a set of metering files is provided, comprising one file per function suspected of possibly leading to a crash, so as to examine whether there exists a link between the use (or the large frequency of use) of a function and the anomaly noted.

The invention also relates to a method of temporal metering of events, in which:

occurrences of physical events are flagged in real time,

at least one clock is accessed so as to obtain a current time of each of these occurrences

and information pertaining to the occurrences and to the corresponding current times is recorded in at least one metering file, this information authorizing an at least partial temporal reconstitution of the occurrences.

According to the invention, a summary processing of the occurrences and of the current times is performed automatically, so as to produce condensed results and the information is recorded in the form of the condensed results, in predefined data structures of prefixed sizes of the metering file, so as to make it possible to keep the size of this file constant during successive recordings of the information.

This method is preferably implemented by means of any one of the modes of embodiment of the metering device of the invention.

A subject of the invention is also a device for temporal analysis of events on the basis of at least one metering file obtained by means of a metering device in which at least two types of distinct results with redundancies are used. This device comprises:

a module for extracting the results recorded in this file,

a module for verifying consistencies of the results respectively of these types of results,

and a module for producing a warning signal intended for a user in the case of inconsistency of these results.

Advantageously, the metering file then being obtained by means of a metering device for which the types of results provide complementary information, the temporal analysis device also comprises:

a module for inputting requests of a user, these requests pertaining to temporal cues relating to the occurrences of the events,

a module for combined processing of the types of results, which module is designed to produce the temporal cues as a function of the information recorded,

and a module for presenting these temporal cues to the user.

The invention applies also to a method of temporal analysis of events corresponding to the events analysis device of the invention, and which is preferably implemented by means of one of the modes of embodiment of the latter.

The invention also relates to a computer program product comprising program code instructions for the execution of the steps of the method of metering or of temporal analysis of events of the invention, when this program is executed on a computer. The expression “computer program product” is understood to mean a computer program medium, which can consist not only of a storage space containing the program, such as a diskette or a cassette, but also of a signal, such as an electrical or optical signal.

The invention will be better understood and illustrated by means of the following examples of embodiment and of implementation, which are in no way limiting, with reference to the appended figures in which:

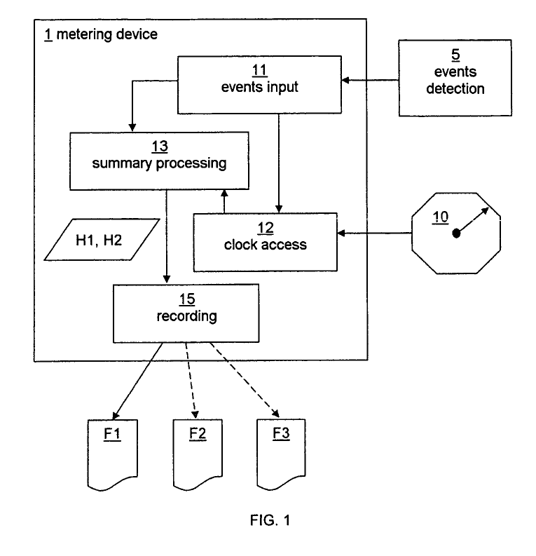

FIG. 1 is a basic diagram of a device for temporal metering of events in accordance with the invention;

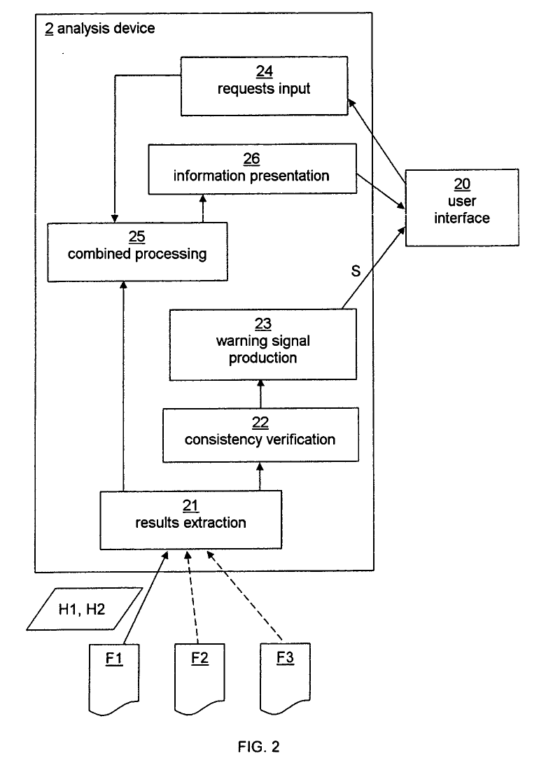

FIG. 2 is a basic diagram of a device for temporal analysis of events which is associated with the device of FIG. 1;

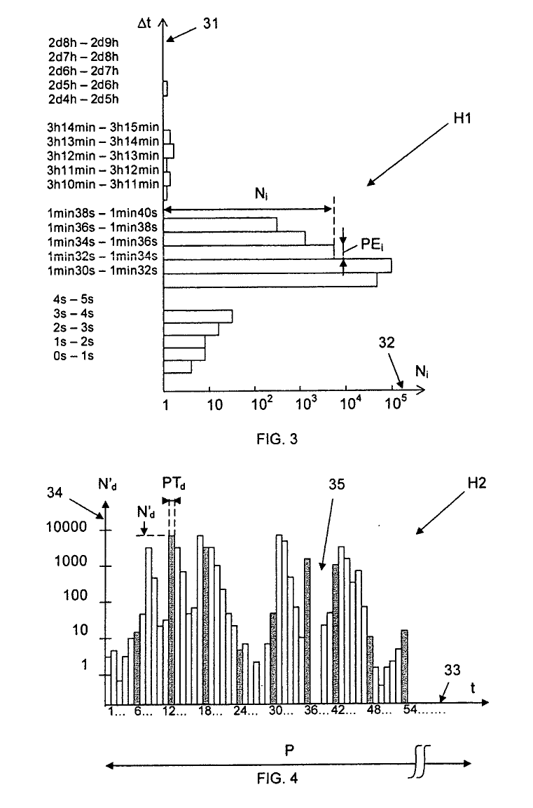

FIG. 3 shows a first type of results obtained with the device of FIG. 1 and designed to be analyzed by means of the device of FIG. 2, in the form of a histogram giving the number of occurrences of events as a function of slots of durations of gaps between two consecutive events;

FIG. 4 shows a second type of results obtained with the device of FIG. 1 and designed to be analyzed by means of the device of FIG. 2, in the form of a histogram giving the number of occurrences of events as a function of consecutive time slots.

In FIGS. 1 and 2, the modules represented are functional units, which may or may not correspond to physically distinguishable units. For example, these modules or some of them may be grouped together within a single component, or constitute functionalities of one and the same piece of software. Conversely, certain modules may possibly be composed of separate physical entities.

A device 1 for temporal metering of events (FIG. 1) is linked to an events detection module 5, capable of detecting any triggering of an event of a predefined category, for example access to a software service by third parties or the triggering of particular operations performed on the machine hosting the device 1 (switch on, access to the Internet, etc.). By way of example, the module 5 is designed to detect three types of distinct events.

The temporal metering device 1 is designed to produce information pertaining to the occurrences of the events considered and to their temporal progress, and to record this information in metering files F1, F2 and F3 associated respectively with the three categories of events detected.

This device 1 comprises a module 11 for real time input of occurrences of events detected by the detection module 5, a module 12 for access to one or more clock(s) 10, making it possible to obtain a current time with each input of one of the occurrences, and a module 15 for recording the information mentioned above in the files F1, F2 and F3.

The device 1 also comprises a module 13 for summary processing of the occurrences and of the current times, producing condensed results which form the information to be saved and transmitting same to the recording module 15. The latter is for its part responsible for recording these condensed results in predefined data structures of fixed sizes of the files F1, F2 and F3.

The files F1, F2 and F3 are made available for a device for temporal analysis 2 of events (FIG. 2), responsible for utilizing the results recorded in these files. In the detailed embodiment, the device 2 is capable, after possible decryption, of verifying the consistency of the information supplied and of supplying specific cues in response to requests formulated by a user.

This device 2 comprises a module 21 for extracting results from the files F1, F2 and F3, a module 22 for verifying consistency within each of the files, of the results extracted therefrom, and a module 23 for producing a signal S to a user interface 20 in case inconsistency is flagged. The consistency of the information is verified separately for each of the files F1, F2 and F3, and consists for example in making sure that the sum of the durations associated with events (such as the durations of gaps between the starts of two consecutive events) does not exceed a ceiling corresponding to a total duration of implementation, or that redundant information is not contradictory.

The temporal analysis device 2 also comprises a unit 24 for inputting requests via the user interface 20, so as to obtain in particular statistical cues (distribution of the occurrences as a function of the hours of the day or of the period of the month, mean duration of gap between two occurrences, etc) or factual cues (number of occurrences arising in such a time slot of the month, duration of an interruption, identification of the interruptions greater than 1 h, etc). A module 25 for combined processing of the results is able to utilize the information extracted from the files F1, F2 and F3 to respond to the requests thus formulated. This module 25 transmits the desired cues, or possibly a message of impossibility of response, to a module 26 for presenting information, which communicates with the user interface 20.

The manner of operation of the devices 1 and 2 will be detailed on a particular case, in which one of the three categories of events consists of calls to a software service. The provisions of implementation are made explicit only for this category of events, a similar course of action being adopted for example for the other categories.

An executable piece of software supplying the software service is situated on a single machine, called the “source machine”. It may be called by all the machines belonging to the same network, and executed on these machines. Access to the software is protected, the protection being tied to the source machine. The metering device 1, present in the source machine, makes it possible to meter all the calls in the file F1. The latter is situated here in the same directory as the executable, and retains a size of a few k-bytes. Its constitution allows the temporal analysis device 2 to verify that the users have not modified it, as is set forth hereinbelow.

The device 1 uses a specific feature of machines organized in a network, namely that all these machines have the same time to within a second, and that write access to a given file can be made only by a single machine at a given instant, even if all these machines have access to this file. When a machine has executed the software, it writes the “date” on which it did it to the file. The clocks 10 are therefore in the present case dispersed in the various machines and synchronized, the access module 12 of the device 1 indirectly receiving the times of these clocks. The machine concerned subtracts moreover from this date, the “date” of the previous call. A duration called Δt is thus obtained.

According to the time spans between two calls, Δt may equal 1 s, 2 s, 3 s . . . 1 min . . . 1 min 20 s . . . 2 min . . . 1 h . . . 1 day . . . 1 week, the durations Δt being sampled in a nonlinear manner (that is to say the sampling stepsize varies). For each stepsize, the summary processing module 13 meters all the durations Δt, storing them in a register corresponding to this stepsize. By virtue of the nonlinear sampling, relevant information is obtained while limiting the storages required. Specifically, while it is useful to ascertain to within a second the duration between two calls separated by 10 s (that is to say with an accuracy of 10%), it is unnecessary to know to within a second the duration between two calls separated by 1 day (to maintain an accuracy of 10%, a stepsize of 2 hours is sufficient).

For example:

For Δt varying from 0 s to 59 s, the stepsize equals one second; sixty registers Rₐ₀ to Rₐ₅₉ are then reserved in the file F1 to meter these durations Δt. If the duration Δt equals 30 s, we add 1 to the register aₐ₂₉. We thus have a histogram of the durations Δt lying between 0 s and 59 s, with a stepsize of 1 second.

For Δt varying from 1 min to 4 min 58 s, the stepsize equals two seconds. In the file F1, are then reserved (5−1)*60/2=120 registers called R_{b0} to R_{b119} to meter these durations Δt. If Δt equals 2 min 17 s, we add 1 to the register R_{b38}. We thus have a histogram of the Δt lying between 1 min and 4 min 58 s, with a stepsize of 2 seconds.

For Δt varying from 5 min to 15 min 55 s, the stepsize equals two seconds. In the file F1, are then reserved (15−5)*60/5=120 registers called R_{c0} to R_{c119} to meter these durations Δt. If Δt equals 10 min 03 s, we add 1 to the register R_{c60}. We thus have a histogram of the Δt lying between 5 min and 15 min 55 s, with a stepsize of 5 seconds.

. . .

For Δt varying from 2 h to 4 h, the stepsize equals 1 min. In the file F1, are then reserved (4−2)*60=120 registers called Rₙ₀ to Rₙ₁₁₉ to meter these durations Δt. If Δt equals 1 h, we add 1 to the register Rₙ₆₀. We thus have a histogram of the Δt lying between 2 h and 2 h 59 min, with a stepsize of 1 min.

. . .

For Δt varying from 1 day to 10 days, the stepsize equals 1 hour. In the file F1, are then reserved (10−1)*24=216 registers called Rₓ₀ to Rₓ₂₁₅ to meter these durations Δt. With Δt equals 8 days, 2 hours, 13 min and 15 s, we add 1 to the register Rₓ₁₉₄. We thus have a histogram of the Δt lying between 1 and 10 days, with a stepsize of 1 hour. P . . .

We thus obtain a histogram H1 (FIG. 3), giving numbers Nᵢ of occurrences of the calls (axis 32) as a function of slots PEᵢ of durations of gap Δt between two consecutive occurrences (axis 31).

By imposing the condition that, at the start of the use of the software, the histogram H1 is blank, it is possible by periodically analyzing it (period P), for example every month, to ascertain the duration of use of the software. The period P is agreed beforehand in the protocol between the client and the supplier of the software, that hosts the temporal analysis device 2. The client thus sends the file F1 to the supplier according to this periodicity (the periodicity may be different for the files F1, F2 and F3, although a grouped send is more practical to implement). In the case illustrated by the histogram H1, it is assumed that one is dealing with a first month of monitoring, hence that the results displayed are directly representative of the events occurring during this month. Beyond that, it is expedient to subtract from the most recent histogram H1 that obtained the previous month, which operation is performed automatically by the temporal analysis device 2.

Let us consider the slot PEᵢ, time slice lying between Δtᵢ and Δtᵢ₊₁, and a number Nᵢ of uses during this time slice, giving the number of times in which the time interval between two calls lies between Δtᵢ and Δtᵢ₊₁. If for example Nᵢ=20, tᵢ=1 h and tᵢ₊₁₌₂ h, and if Nᵢ is the only nonzero value of the numbers of occurrences, then we know that the software has been used to the minimum for 20 hours and to the maximum for 40 hours, and that 20 calls to the software took place within this duration. In another example Nᵢ=1, tᵢ₌4 days and tᵢ₊₁=5 days, we know that an interruption of 4 or 5 days has occurred.

In current use mode, the client sends the file F1 thus defined every month at the same time. By differencing on the basis of the slots PEᵢ the content of the histograms H1 from one month to another, the temporal analysis device 2 determines the number of occurrences Nᵢ for the current month. The file F1 is therefore kept at the client's and automatically updated in tempo with the calls, and has not been manipulated by this client.

A second histogram H2 (FIG. 4) is recorded in the file F1. It gives the number N′ⱼ of accesses to the software (axis 34) during each time slot PTⱼ of a period P (axis 33), corresponding here to each hour of the month for the first 54 hours. The month is therefore broken down into 24 h*31 days, i.e. 744 registers. Just as for the histogram H1, the histogram H2 represented here is established during the first month. For the succeeding months, the results are obtained from the file F1 communicated by the client, by subtracting from the most recent histogram H2, that obtained the previous month.

If an interruption of more than an hour occurs, it is therefore possible to identify it, since the registers tied to these hours are not incremented during the month considered. Thus, it is noted that an interruption of service (referenced 35 in the histogram H2) has probably taken place for two hours (hours 36 and 37), since 24 hours earlier, the number of calls was very high (around 3000 calls for the thirteenth hour, and around 600 for the fourteenth).

By using the two types of information storage described hereinabove, the temporal analysis device 2 (verification module 22) can detect any frauds of the client, in particular in the cases set forth hereinbelow:

a sizable duration of gap Δt (for example greater than two days) has been detected in the histogram H1, corresponding to a number of hours of non use (for example 50) in the histogram H2, although the client declares that he had not stopped the software call service: hence, at a given moment he made a copy of the file F1, and he replaced the current file F1 by this copy two days later;

a no-call hour is flagged in the histogram H2, although in the histogram H1, the durations of gap Δt lying between 1 h and 2 h are all zero (one of them ought to be nonzero since there was an interruption of at least one hour, hence a dwell of at least one hour between two calls): the client has therefore modified the file F1, since there is inconsistency;

the number of calls is zero for all the hours in the histogram H2, although in the histogram H1, one of the durations of gap Δt greater than 2 hours is associated with calls: the client has modified the file F1, since there is inconsistency.

Moreover:

at any moment, the total sum of the contents of the registers of the histogram H2 must be equal to the total sum of the contents of the registers per hour of the histogram H1;
and over a month, the sums ΣNᵢΔtᵢ and ΣNᵢΔtᵢ₊₁ in the histogram H2 must be respectively less than and greater than a month, with Nᵢ corresponding to the register storing the dwells between calls lying between Δtᵢ and Δtᵢ₊₁ (slot PEᵢ).

If this is not the case, and assuming that the calculation of the time in the machines is accurate, the file F1 has been modified.

According to a particular illustration, the mean number of calls to the software service in a month is 1 million, i.e. one call every 2.6 seconds. If a low estimate is made, for example that the number of calls is 100 000 per month, then there is a call every 26 seconds. The breakdown indicated in table 1 is then effected, in slices of duration of gap Δt (variable duration between the values Δt), while each time indicating a minimum error and a maximum error in the duration of gap Δt per slot PEᵢ.

TABLE 1
Stepsize and errors in the histogram H1

| | Stepsize of | | | | |
|---|---|---|---|---|---|
| Intervals of | the slots | | | | Number of |
| durations Δt | PEᵢ | | Min error | Max error | registers |
| 1 s → 5 min | 1 | s | 0.33% | 100% | 300 |
| 5 min 2 s → 10 min | 2 | s | 0.33% | 0.67% | 150 |
| 10 min 5 s→30 min | 5 | s | 0.83% | 0.28% | 240 |
| 30 min 10 s→60 min | 10 | s | 0.56% | 0.28% | 180 |
| 1 h 0 min 20 s→2 h | 20 | s | 0.28% | 0.56% | 180 |
| 2 h 0 min 30 s→4 h | 30 | s | 0.21% | 0.42% | 240 |
| 4 h 1 min→6 h | 1 | min | 0.28% | 0.42% | 120 |
| 6 h 2 min→8 h | 2 | min | 0.42% | 0.56% | 60 |
| 8 h 4 min→12 h | 4 | min | 0.56% | 0.84% | 60 |
| 12 h→17 h 54 min | 6 | min | 0.56% | 0.84% | 60 |
| 18 h→23 h 50 min | 10 | min | 0.70% | 0.93% | 36 |
| 1 d→1 d 23 h 45 min | 15 | min | 0.52% | 1.04% | 96 |
| 2 d→4 d 23 h 30 min | 30 | min | 0.42% | 1.04% | 96 |
| 4 d→8 d 23 h | 1 | h | 0.42% | 1.04% | 96 |
| 8 d→15 d 2 h | 2 | h | 0.42% | 1.04% | 96 |
| 16 d→1 month | 4 | h | 0.42% | 1.04% | 96 |

The total number of registers for the histogram H1 therefore equals 2106, i.e. a memory space of 8424 bytes while storing the registers on 32 bits.

In the same way, if the days of the month are broken down into hours for the histogram H2, we obtain a number of registers of 744, i.e. 2976 bytes while storing the registers on 32 bits.

For the sake of confidentiality, this information is encrypted for example in packets of 8 words (i.e. 32 bytes).

1. A device for temporal metering of events, comprising:
means for associating a current time with each input of occurrence of a physical event,
means for summary processing of said occurrences and of the current times so as to produce condensed results;
and a means for recording in at least one metering file, of information containing said
condensed results in predefined data structures of prefixed sizes, so as to make it possible to keep the size of said file constant during successive recordings of said information, said information authorizing an at least partial temporal reconstruction of the occurrences.

2. The temporal metering device as claimed in claim 1, wherein the summary processing module is designed to produce at least two types of distinct results, at least one of said types of results comprising redundancies with respect to the other types of results, so as to allow checks of consistency of said results.

3. The temporal metering device as claimed in claim 2, wherein the summary processing module is designed so that the types of results provide complementary information.

4. The temporal metering device as claimed in claim 3, wherein the types of results comprise:
a first type of results consisting of numbers of the occurrences per slot of durations of gaps between two of the consecutive occurrences
and a second type of results consisting of numbers of the occurrences per consecutive time slot of a predetermined period.

5. The temporal metering device as claimed in claim 4, wherein the slots of durations of gaps of the first type of results have amplitudes increasing not strictly with the durations.

6. The temporal metering device as claimed in claim 1, wherein the physical events comprise calls to a piece of software situated on a source machine by appliances able to communicate with the machine.

7. The temporal metering device as claimed in claim 1, wherein the physical events comprise telephone calls.

8. The temporal metering device as claimed in claim 1, wherein the physical events comprise predefined maneuvers in a motor vehicle.

9. The temporal metering device as claimed in claim 1, wherein the physical events comprise uses of computer functionalities available on a machine and liable to undergo malfunctions on account of technical problems.

10. A method of temporal metering of events comprising the steps of:
associating a current time with each input of occurrence of a physical event,
processing said occurrences and said current times so as to produce condensed results, recording in at least one metering file, information containing the condensed results, in predefined data structures of prefixed sizes, so as to make it possible to keep the size of the file constant during successive recordings of the information,
the information authorizing an at least partial temporal reconstruction of the occurrences.

11. A device for temporal analysis of events on the basis of at least one metering file obtained by means of a metering device in accordance with claim 2, comprising:
a module for extracting the results recorded in the file,
a module for verifying consistencies of the results respectively of the types of results,
and a module for producing a warning signal intended for a user in the case of inconsistency of the results.

12. The temporal analysis device as claimed in claim 11, wherein the metering file being obtained by means of a metering device as claimed in claim 3, said temporal analysis device also comprises:
a module for inputting requests of a user, the requests pertaining to temporal cues relating to the occurrences of the events,
a module for combined processing of the types of results, which module is designed to produce said temporal cues as a function of the information recorded,
and a module for presenting said temporal cues to the user.

13. A method of temporal analysis of events on the basis of at least one metering file obtained by means of a metering device in accordance with claim 2, in which:
results recorded in the file are extracted,
the consistencies of the results respectively of the types of results are verified automatically,
and a warning signal intended for a user in the case of inconsistency of the results is produced.

14. A computer program product comprising program code instructions for the execution of the steps of the method as claimed in claim 10 when the program is executed on a computer.
